(19) United States
(12) Patent Application Publication
(10) Pub. No.: US 2026/0246339 A1
(43) Pub. Date: Aug. 20, 2026

(54) STATOR COOLING SYSTEM AND A MOTOR INCLUDING THE SAME

(71) Applicants: HYUNDAI MOTOR COMPANY, Seoul (KR); KIA CORPORATION, Seoul (KR)

(72) Inventors: Il Suk Yang, Hwaseong-si (KR); Hong Youl Lee, Hwaseong-si (KR); Min Gyun Chung, Hwaseong-si (KR); Young Jin Shin, Hwaseong-si (KR); Min Bok Cho, Hwaseong-si (KR); Seok Hoon Jo, Hwaseong-si (KR); Young Chul Kim, Hwaseong-si (KR); Jae Hyeok Song, Hwaseong-si (KR)

(73) Assignees: HYUNDAI MOTOR COMPANY, Seoul (KR); KIA CORPORATION, Seoul (KR)

(21) Appl. No.: 19/255,118

(22) Filed: Jun. 30, 2025

(30) Foreign Application Priority Data
Feb. 14, 2025 (KR) 10-2025-0019424

(51) Int. Cl. H02K 9/19

(52) U.S. Cl. CPC H02K 9/19

(57) ABSTRACT

A stator cooling system includes a stator around which a plurality of coils are wound, a housing provided to cover at least a portion of an external surface of the stator and having an oil supply port, and at least one cooling pipe configured to spray oil supplied through the oil supply port onto at least one of the plurality of coils, wherein the at least one cooling pipe is configured to spray oil into at least one communication path formed between the plurality of coils.

### CROSS-REFERENCE TO RELATED APPLICATION(S)

This application claims benefit of priority to Korean Patent Application No. 10-2025-0019424 filed on Feb. 14, 2025, in the Korean Intellectual Property Office, the disclosure of which is incorporated herein by reference in its entirety.

### BACKGROUND

### 1. Field

The present disclosure relates to a stator cooling system and a motor including the same.

### 2. Description of Related Art

Eco-friendly vehicles, such as electric vehicles (EVs), hybrid vehicles (HEVs/PHEVs), and fuel cell vehicles (FCEVs), are all electric vehicles in a broad sense that they run on electric motors. Eco-friendly vehicles are equipped with a motor, which is a driving source (e.g., driving power source) for driving vehicles and an inverter configured to convert direct current (DC) from a high-voltage power source into alternating current (AC) and applying the same to the motor to drive and control the motor. In this manner, eco-friendly vehicles generate driving power using a motor, and the motor driving the eco-friendly vehicle, i.e. a driving motor, should have high efficiency and output density. The efficiency of the driving motor in recently developed eco-friendly vehicles is known to be about 90%, and a significant portion of the remaining loss (e.g., energy loss) is heat loss. Therefore, it is essential to have a stable thermal management system to meet the continuous demands for miniaturization, high output, and high efficiency of the motor.

When the motor is driven, a large amount of heat is generated by coils, etc., so cooling of the main parts, such as the coils, is essential, and cooling an embedded permanent magnet synchronous motor (IPSM), which is widely used as a driving motor of vehicles, plays an important role in the efficiency of the motor and the protection of core parts (permanent magnets, coils, etc.). When the temperature of the permanent magnet reaches a certain level (e.g., temperature) or higher, permanent magnet demagnetization may occur, weakening the strength of magnetic force, which has a significant negative effect on the efficiency of the motor, etc.

As a result, in order to prevent a motor system from reaching an overtemperature or overheated state exceeding an allowable temperature which causes overtemperature damage in motor stator coils, etc. or demagnetization of the permanent magnets of the motor, effective heat management and cooling of the motor system are required. To this end, an appropriate heat management and cooling system is required so that the motor may be driven stably within the allowable temperature range.

### SUMMARY

An aspect of the present disclosure is to provide a stator cooling system with improved cooling performance and a motor including the same.

Another aspect of the present disclosure is to provide a stator cooling system and a motor including the same, capable of reducing manufacturing costs.

According to an aspect of the present disclosure, a stator cooling system includes: a stator around which a plurality of coils are wound; a housing provided to cover at least a portion of an external surface of the stator and having an oil supply port; and at least one cooling pipe configured to spray oil supplied through the oil supply port onto at least one of the plurality of coils, wherein the at least one cooling pipe is configured to spray oil into at least one communication path formed between the plurality of coils.

In the stator cooling system according to embodiments of the present disclosure, the cooling pipe may be formed of a plastic material.

In the stator cooling system according to embodiments of the present disclosure, the cooling pipe may spray oil toward a communication path exposed to an inner circumferential surface of the plurality of coils.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a partial cross-sectional view of a stator cooling system according to an embodiment of the present disclosure;

FIG. 2 is another partial cross-sectional view of a stator cooling system according to an embodiment of the present disclosure;

FIG. 3 is a diagram illustrating an arrangement relationship between a cooling pipe and a stator in a stator cooling system according to an embodiment of the present disclosure;

FIG. 4 is a perspective view of a cooling pipe included in a stator cooling system according to an embodiment of the present disclosure;

FIG. 5 is a diagram illustrating a positional relationship between a cooling pipe and a coil provided in a stator included in a stator cooling system according to an embodiment of the present disclosure;

FIG. 6 is an axial cross-sectional view of a coil provided in a stator in a stator cooling system according to an embodiment of the present disclosure; and

FIGS. 7A-7D are diagrams illustrating a manufacturing process of a cooling pipe included in a stator cooling system according to an embodiment of the present disclosure.

### DETAILED DESCRIPTION

While the present disclosure may be modified in various ways and take on various alternative forms, specific embodiments thereof are illustrated in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It should be understood that, although the terms “first,” “second,” etc., may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

Terms such as “unit, part, portion, etc.” may be used to describe various components, but the components should not be limited by these terms. The above terms may refer to not only physically/visually distinct components, but also to functions or components of a portion even if the corresponding portion is not clearly divided.

The terms used herein to describe embodiments of the present disclosure are not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It should be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those having ordinary skill in the art to which the present disclosure pertains. Such terms as defined in generally used dictionaries should be construed to have the same meanings as those of the contexts of the related art, and unless clearly defined in the application, they should not be construed to have ideally or excessively formal meanings.

In the description below, terms “front,” “rear,” “top,” “bottom,” “above,” “below,” etc. used in relation to directions are described based on the illustration in the drawing. When a component, unit, controller, device, element, apparatus or the like of the present disclosure is described as having a purpose or performing an operation, function, or the like, the component, unit, controller, device, element, or apparatus should be considered herein as being “configured to” meet that purpose or perform that operation or function. Each component, unit, controller, device, element, apparatus, and the like may separately embody or be included with a processor and a memory, such as a non-transitory computer readable media, as part of the apparatus.

Embodiments of the present disclosure are described in detail below with reference to the accompanying drawings.

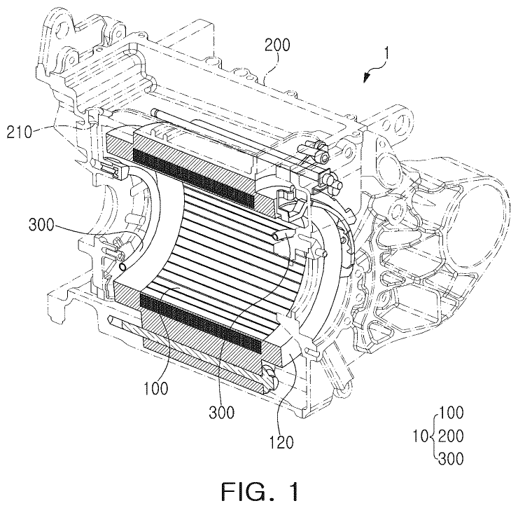

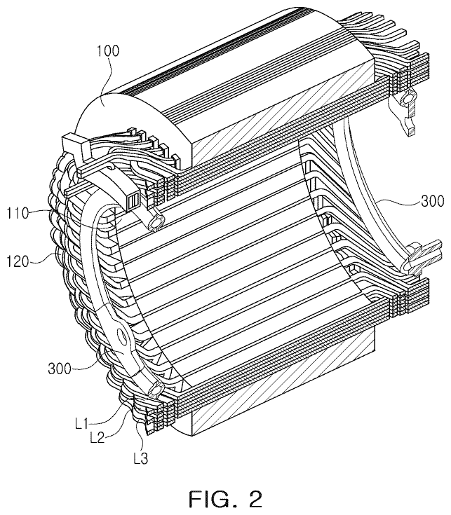

FIG. 1 is a partial cross-sectional view of a stator cooling system according to an embodiment of the present disclosure. FIG. 2 is a partial cross-sectional view of a stator cooling system according to an embodiment of the present disclosure, different from the partial cross-sectional view of FIG. 1.

Referring to FIGS. 1 and 2, a stator cooling system 10 according to an embodiment of the present disclosure may include a stator 100, a housing 200, and a cooling pipe 300.

The stator 100 may be provided with a plurality of annular stator cores stacked in an axial direction. The stator 100 may include teeth 110. The teeth 110 may be provided on an inner circumferential surface of the stator 100. The teeth 110 may be provided as an internal surface of the stator core protrudes inwardly in a radial direction. A plurality of teeth 110 may be provided in a circumferential direction (e.g., circumferentially). Slots may be formed between the plurality of teeth 110. A coil 120 may be inserted into the slot. The coil 120 may be inserted into the slot between the teeth 110 and may be connected to an external power source to form an electromagnetic field. For example, the coil 120 may be provided as a rectangular wire. For example, the coil 120 may be provided as a hairpin coil. A plurality of coils 120 may be inserted into the slot in the radial direction.

The coil 120 may be exposed to both sides of the stator 100 in the axial direction. For example, when the coil 120 is provided as a hairpin coil, a head portion of the coil 120 may be exposed to the outside of one axial end of the stator 100, and a leg portion of the coil 120 may be exposed to the outside of the other axial end of the stator 100. The cooling pipe 300 may cool the coil 120 by spraying oil on the internal surface of the coil 120 exposed to both sides of the stator 100 in the axial direction.

A plurality of coils 120 may be provided in a circumferential direction. The plurality of coils may be provided so that at least some of the plurality of coils overlap in a radial direction. The coil 120 may form a layer connected in the circumferential direction. A plurality of layers may be provided. In other words, the plurality of coils 120 may form a plurality of layer layers L1, L2, and L3 in the radial direction. The number of layers formed by the coils 120, for example, the number of layers or coils 120 included in a coil stack may be changed according to the specifications of the motor.

A communication path (120a, see FIG. 5) may be formed in the coils 120 or the coil stack. The plurality of layer layers L1, L2, and L3 may form or define the communication path 120a. The communication path 120a may be formed by a mechanical shape of the plurality of coils 120 or the coil stack. In other words, the communication path 120a may refer to a space penetrating the plurality of layers L1, L2, and L3 in the radial direction when the plurality of layers L1, L2, and L3 are formed the plurality of coils 120 or the coil stack. More specifically, the communication path 120a may refer to a space formed as the plurality of coils 120 arranged in the radial direction do not overlap in the radial direction when the plurality of coils 120 or the coil stack is inserted into the stator 100. The communication path 120a may connect an internal space and an external space of the plurality of layers L1, L2, and L3. In other words, the communication path 120a may pass through the plurality of layers L1, L2, and L3. The communication path 120a may connect the internal space and the external space of the plurality of layers L1, L2, and L3 in the radial direction. The plurality of coils 120 may be arranged in the radial direction of the stator 100. The communication path 120a may be formed in the radial direction to pass through the plurality of coils 120. A plurality of communication paths 120a may be provided in the circumferential direction and the axial direction of the stator 100.

The housing 200 may be provided to cover at least a portion of the external surface of the stator 100. The housing 200 may be provided with an oil supply port 210. The oil supply port 210 may be connected to an external oil supply unit. Oil supplied from the oil supply unit may be supplied to the cooling pipe 300 through the oil supply port 210.

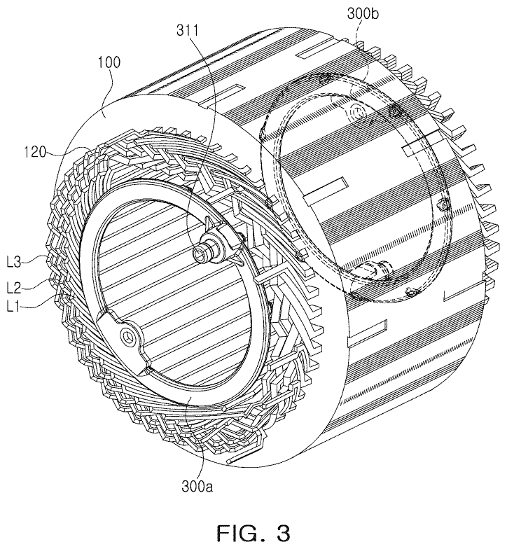

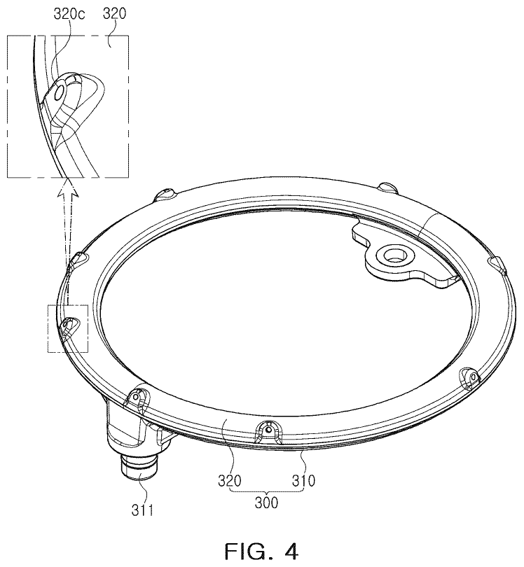

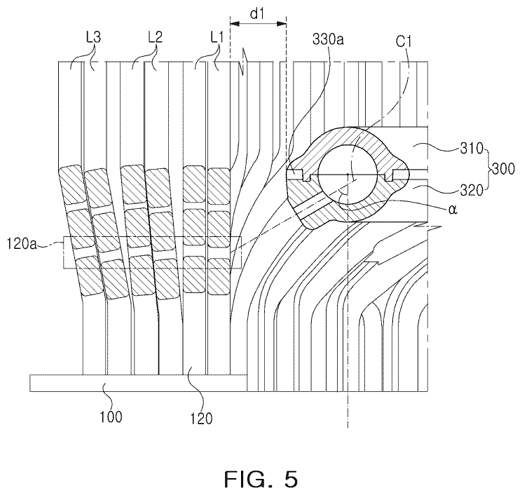

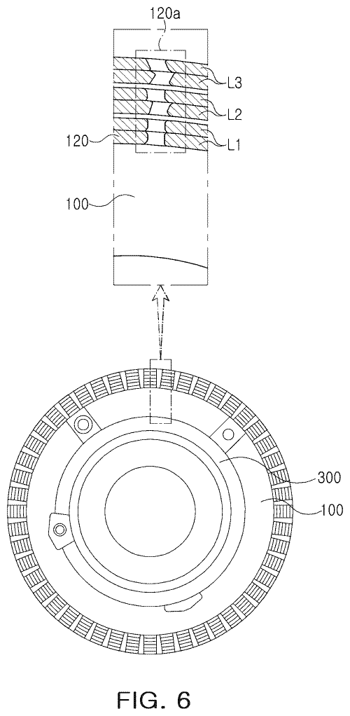

FIG. 3 is a diagram illustrating an arrangement relationship between a cooling pipe and a stator in a stator cooling system according to an embodiment of the present disclosure. FIG. 4 is a perspective view of a cooling pipe included in a stator cooling system according to an embodiment of the present disclosure. FIG. 5 is a diagram illustrating a positional relationship between a cooling pipe and a coil provided in a stator included in a stator cooling system according to an embodiment of the present disclosure. FIG. 6 is an axial cross-sectional view of a coil provided in a stator in a stator cooling system according to an embodiment of the present disclosure

Referring to FIGS. 3-6, the cooling pipe 300 may be provided on both sides of the stator 100 in the axial direction. The cooling pipe 300 may be provided such that the external surface thereof faces the internal surface of the plurality of coils 120 or the coil stack. The cooling pipe 300 may spray oil supplied through the oil supply port 210 of the housing 200 onto the plurality of coils 120 or the coil stack of the stator 100. For example, the cooling pipe 300 may spray oil onto the internal circumferential surface of the plurality of coils 120 or the coil stack. For example, the cooling pipe 300 may spray oil to at least one of the plurality of communication paths 120 formed between the plurality of coils 120. The cooling pipe 300 may spray oil into one or a first opening of the communication path 120a exposed to the internal circumferential surface of the plurality of coils 120 or the coil stack. Oil introduced into the first opening of the communication path 120a may flow outwardly in the radial direction toward an other or second opening of the communication path 120a and may contact the plurality of coils 120 arranged in the radial direction. Since the oil flows into the communication path 120a and contacts the plurality of coils 120 arranged in the radial direction, the cooling effect of the plurality of coils 120 or the coil stack by the oil may be improved.

The cooling pipe 300 may be formed of a plastic material. For example, the cooling pipe 300 may be formed of high-performance engineering plastic having excellent mechanical strength, dimensional stability, and the like, even at high temperatures. By forming the cooling pipe 300 with a plastic material, an insulation distance d1 between the cooling pipe 300 and the plurality of coils 120 or coil stack may be minimized or ignored. Here, the insulation distance d1 may refer to a distance between the radial outer side of the cooling pipe 300 and the radial internal circumferential surface of the plurality of coils 120 or the coil stack. For example, the insulation distance d1 may be provided to be 14.5 mm or less, and, for example, 3.5 mm or more and 7.5 mm or less.

By forming the cooling pipe 300 with a plastic material, the cooling pipe 300 may be disposed as close as possible to the internal circumferential surface of the plurality of coils 120 or the coil stack. By minimizing a gap between the cooling pipe 300 and the plurality of coils 120 or the coil stack, the reliability of an oil injection position and an oil injection speed may be improved. As a result, the cooling performance of the plurality of coils 120 or the coil stack may be improved.

The cooling pipe 300 may include a first cooling pipe 300a provided at one (e.g., a first) axial end of the stator 100 and a second cooling pipe 300b provided at the other (e.g., a second) axial end of the stator 100. The first cooling pipe 300a and the second cooling pipe 300b may be provided to have the same structure. The first cooling pipe 300a may spray oil onto the plurality of coils 120 or the coil stack exposed to the outside of one (e.g., a first) axial end of the stator 100. The second cooling pipe 300b may spray oil onto the plurality of coils 120 or the coil stack exposed to the outside of the other (e.g., a second) axial end of the stator 100. The first cooling pipe 300a and the second cooling pipe 300b may each spray oil onto the inner circumferential surface of the plurality of coils 120 or the coil stack. For example, the first cooling pipe 300a and the second cooling pipe 300b may spray oil toward the communication path 120a exposed to the internal circumferential surface of the plurality of coils 120 or the coil stack. The oil sprayed into the communication path 120a may pass through the plurality of coils 120 or the coil stack in the radial direction and cool the plurality of coils 120 or the coil stack. In other words, the oil may pass through the plurality of layers L1, L2, and L3 forming the plurality of coils 120 or the coil stack in the radial direction and come into contact with the plurality of coils 120 or the coil stack to cool the plurality of coils 120 or the coil stack.

The cooling pipe 300 may be provided in a ring shape. The cooling pipe 300 may be provided with an oil injection hole 320c for oil injection. A plurality of oil injection holes 320c may be provided to be spaced apart from each other by a predetermined distance in the circumferential direction of the cooling pipe 300. The oil injection holes 320c may be provided to extend in the radial direction to connect the internal space and the external space of the cooling pipe 300. The oil injection holes 320c may be provided to be inclined. For example, the oil injection holes 320c may be provided to be inclined toward the inside in the axial direction. An insulator for insulation may be provided to be adjacent to the leg portion of the plurality of coils 120 or the coil stack. The insulator may be provided on the axial outer end of the leg portion. A communication path may not be formed by the insulator in the portion of the plurality of coils 120 or the coil stack in which the insulator is provided. Accordingly, the oil injection hole 320c may be inclined toward the axial inner side so that the oil injected from the cooling pipe 300 may be supplied to the communication path 120a. For example, the oil injection hole 320c may be inclined toward the communication path 120a formed on the innermost side in the axial direction among the communication paths 120a formed in the plurality of coils 120 or the coil stack, or the communication path 120a formed on the next innermost side in the axial direction.

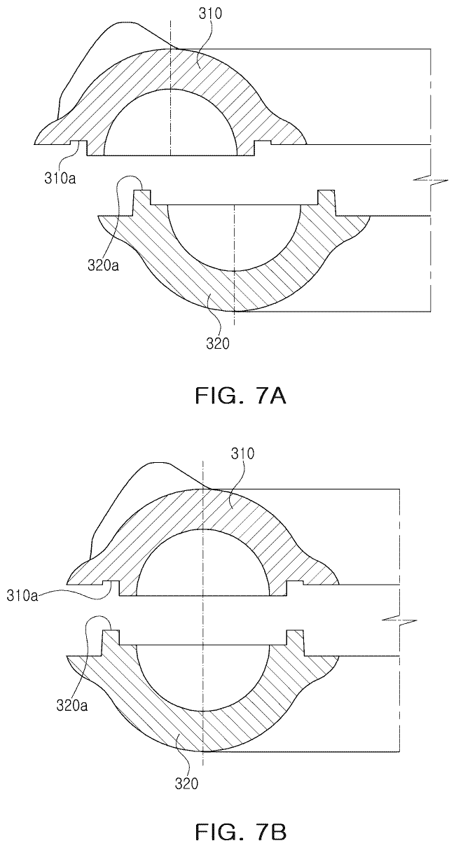

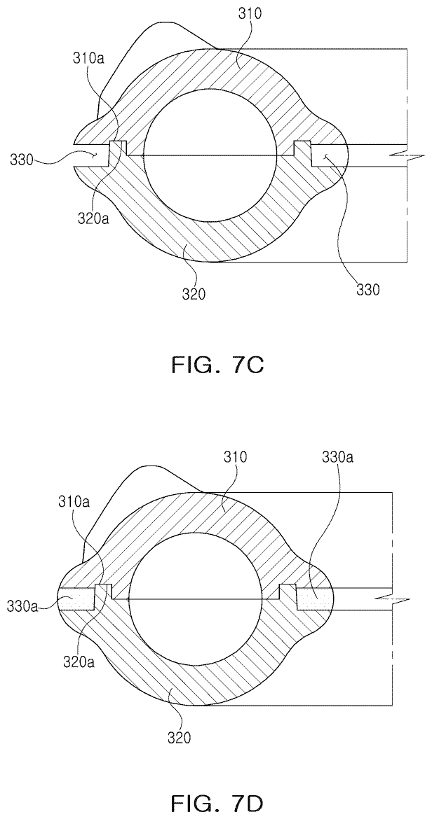

FIGS. 7A-7D are diagrams illustrating a manufacturing process of a cooling pipe included in a stator cooling system according to an embodiment of the present disclosure.

Referring to FIGS. 7A-7D, the cooling pipe 300 may include, for example, a first shell 310 and a second shell 320. The first shell 310 and the second shell 320 may each be provided in a ring shape with one axial side open. The first shell 310 and the second shell 320 may each have a semicircular cross-section in the circumferential direction. The open surfaces of the first shell 310 and the second shell 320 may be coupled to each other. A coupling groove 310a may be provided on the open surface of the first shell 310. In other words, the coupling groove 310a may be provided in one surface of the first shell 310 facing the second shell. The coupling groove 310a may be provided continuously in the circumferential direction. The coupling groove 310a may be provided on the radially inner and outer sides. A blocking wall 320a may be provided from the open surface of the second shell 320 and inserted into the coupling groove 310a. The blocking wall 320a may be provided continuously in the circumferential direction. The blocking wall 320a may be provided on the radially inner and outer sides. When the blocking wall 320a is inserted into the coupling groove 310a, one surface of the first shell 310 and one surface of the second shell 320 may come into contact with each other, and an oil flowing path may be formed between the first shell 310 and the second shell 320. In addition, when the blocking wall 320a is inserted into the coupling groove 310a, an injection-mold groove 330 may be formed in the circumferential direction on the radially inner and radially outer sides of the first shell 310 and the second shell 320. The radially inner and outer sides of the first shell 310 and the second shell 320 may be the radial inner and sides with respect to the plurality of coils 120 or the coil stack. The injection-mold groove 330 may be provided continuously in the circumferential direction. An injection-molded material 330a coupling the first shell 310 to the second shell 320 may be provided in the injection-mold groove 330. The injection-molded material 330a may be, for example, a weld bead. The first shell 310 and the second shell 320 may be coupled to form a ring-shaped passage through which oil flows.

The first shell 310 may include an inlet 311. The inlet 311 may be connected to the housing 200 to receive oil. For example, the inlet 311 may be connected to the oil supply port 210 to receive oil from the oil supply port 210.

The second shell 320 may include an oil injection hole 320c. A plurality of oil injection holes 320c may be provided in the circumferential direction. The oil injection holes 320c may be formed by radially penetrating the second shell 320 toward the coil 120. At this time, the oil injection hole 320c may be formed to be inclined at a predetermined angle α toward the axial inner side. The oil injection hole 320c may be formed toward one side opening of the communication path 120a exposed to the internal circumferential surface of the plurality of coils 120 or the coil stack. The oil injection hole 320c may be provided so that a center line c1 faces one side opening of the communication path 120a.

The cooling pipe 300 may be injection-molded. For example, a die slide injection (DSI) molding method may be used as an injection molding method of the cooling pipe 300. The cooling pipe 300 may be manufactured through primary and secondary injection processes. For example, the first shell 310 and the second shell 320 may be primarily injection molded (see FIG. 7A). When the first shell 310 and the second shell 320 are injection-molded, a mold into which the first shell 310 is injected may be slidably moved. The mold may be slidably moved so that the center of the first shell 310 and the center of the second shell 320 match (see FIG. 7B). When the centers of the first shell 310 and the second shell 320 match, the mold into which the first shell 310 is injected and the mold into which the second shell 320 is injected may be joined. As the molds are joined, the open one surface of the first shell 310 and the open one surface of the second shell 320 may come into contact with each other (see FIG. 7C). The open one surface of the first shell 310 and the open one surface of the second shell 320 may be brought into contact with each other by a sliding movement of the mold into which the first shell 310 is injected. The blocking wall 320a of the second shell 320 may be inserted into the coupling groove 310a of the first shell 310. An injection-mold groove 330 may be formed in the circumferential direction on the radially inner side and the radially outer side of the first shell 310 and the second shell 320. A secondary injection process may be performed on the injection-mold groove 330. For example, a secondary injection-molded material 330a may be injected into the injection-mold groove 330 (see FIG. 7D). The secondary injection-molded material 330a may be, for example, a weld bead. The secondary injection-molded material 330a may couple the first shell 310 to the second shell 320. During the secondary injection molding, the blocking wall 320a may prevent the injection-molded material 330a from flowing into the first shell 310 and the second shell 320.

A motor 1 may include the stator cooling system 10. In addition, the motor 1 may include a rotor. The rotor is a structure that may rotate inside the stator 100 and may include a cylindrical rotor core and a magnet provided in the rotor core.

The stator cooling system 10 according to an embodiment of the present disclosure includes the cooling pipes 300 on both sides of the stator 100 in the axial direction and sprays oil on the inner circumferential surface of the plurality of coils 120 or the coil stack as described above, thereby effectively cooling the stator 100.

At this time, by forming the cooling pipe 300 with a plastic material, the cooling pipe 300 and the plurality of coils 120 or the coil stack may be arranged as close as possible to improve the oil injection reliability and cooling efficiency of the cooling pipe 300.

In addition, by manufacturing the cooling pipe 300 using the DSI method, not only may the manufacturing cost be reduced, but also the product appearance quality may be improved.

The stator cooling system and the motor including the same according to embodiments of the present disclosure may have improved cooling performance.

In addition, the stator cooling system and the motor including the same according to embodiments of the present disclosure may reduce the manufacturing costs.

While example embodiments have been illustrated and described above, it should be apparent to those of ordinary skill in the art that modifications and variations could be made without departing from the scope of the present disclosure as defined by the appended claims.

What is claimed is:

1. A stator cooling system comprising:
a stator around which a plurality of coils are wound;
a housing provided to cover at least a portion of an external surface of the stator and having an oil supply port; and
at least one cooling pipe configured to spray oil supplied through the oil supply port onto at least one of the plurality of coils,
wherein the at least one cooling pipe is configured to spray oil into at least one communication path formed between the plurality of coils.

2. The stator cooling system of claim 1, wherein
the plurality of coils are arranged in a radial direction of the stator,
the at least one communication path is formed on an outer side with respect to an axial direction of at least one of both ends of the stator, and
the at least one communication path is formed in a radial direction to pass through the plurality of coils.

3. The stator cooling system of claim 1, wherein the at least one communication path includes a plurality of communication paths in circumferential and axial directions of the stator.

4. The stator cooling system of claim 1, wherein the at least one cooling pipe is formed of a plastic material.

5. The stator cooling system of claim 4, wherein a radial distance between a radial outer side of the at least one cooling pipe and an inner circumferential surface of the plurality of coils is provided to be 3.5 mm or more and 7.5 mm or less.

6. The stator cooling system of claim 1, wherein
the at least one cooling pipe includes:
a first cooling pipe provided at a first axial end of the stator; and
a second cooling pipe provided at a second axial end of the stator.

7. The stator cooling system of claim 6, wherein the first cooling pipe is configured to spray oil onto an inner circumferential surface of the plurality of coils exposed to an outside of a first end of the stator in an axial direction, and the second cooling pipe is configured to spray oil onto the inner circumferential surface of the plurality of coils exposed to an outside of a second end of the stator in the axial direction.

8. The stator cooling system of claim 7, wherein the first cooling pipe and the second cooling pipe are configured to spray oil toward the at least one communication path exposed to the inner circumferential surface of the plurality of coils.

9. The stator cooling system of claim 8, wherein oil sprayed from the first cooling pipe and the second cooling pipe passes through the plurality of coils in a radial direction and cools the coils.

10. The stator cooling system of claim 1, wherein the at least one cooling pipe is provided in a ring shape and has a plurality of oil injection holes in a circumferential direction.

11. The stator cooling system of claim 10, wherein an outer circumferential surface of the at least one cooling pipe is provided to face an inner circumferential surface of the plurality of coils.

12. The stator cooling system of claim 11, wherein
the at least one cooling pipe includes:
a first shell having an inlet connected to the housing configured to receive oil therethrough; and
a second shell connected to the first shell and together with the first shell forming a path through which oil is configured to flow and having the plurality of oil injection holes.

13. The stator cooling system of claim 12, wherein the plurality of oil injection holes is formed to radially penetrate through the second shell toward the plurality of coils.

14. The stator cooling system of claim 13, wherein the plurality of oil injection holes is formed to be inclined inwardly in an axial direction.

15. The stator cooling system of claim 12, wherein a coupling groove is provided on one surface of the first shell in a circumferential direction facing the second shell, and a blocking wall configured to be inserted into the coupling groove is provided on one surface of the second shell in the circumferential direction facing the first shell.

16. The stator cooling system of claim 15, wherein, based on the blocking wall being inserted into the coupling groove, an injection-mold groove is formed in the circumferential direction on a radial inner side and a radial outer side of the first shell and the second shell.

17. The stator cooling system of claim 16, wherein the injection-mold groove is provided with an injection-molded material coupling the first shell to the second shell.

18. A motor comprising the stator cooling system of claim 1.

19. A stator cooling system comprising:
a stator around which a plurality of coils are wound;
a housing including an oil supply port; and
a cooling pipe configured to spray oil into a communication path formed between the plurality of coils.

20. A method of manufacturing a cooling pipe, the method comprising:
inserting a blocking wall of a second shell into a coupling groove of a first shell, forming an injection-mold groove; and
injection molding an injection-molded material in the injection-mold groove, coupling the first shell and the second shell.
